(19) United States
(12) Patent Application Publication
(10) Pub. No.: US 2008/0242541 A1
(43) Pub. Date: Oct. 2, 2008

(54) THERMAL TRANSFER RECORDING INK SHEET, AND THERMAL TRANSFER RECORDING METHOD

(75) Inventors: Yoshihiko FUJIE, Kanagawa (JP); Hisashi MIKOSHIBA, Kanagawa (JP); Naotsugu MURO, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/056,787

(22) Filed: Mar. 27, 2008

(30) Foreign Application Priority Data
Mar. 30, 2007 (JP) 2007-092236

(51) Int. Cl. B41M 5/26; B41M 5/40

(52) U.S. Cl. 503/201; 428/32.6

(57) ABSTRACT

A thermal transfer recording ink sheet comprising a substrate sheet and a color-carrying layer, wherein the dye-carrying layer comprises an anthraquinone dye of the following formula (1) to (4) and an azo dye of the following formula (5):

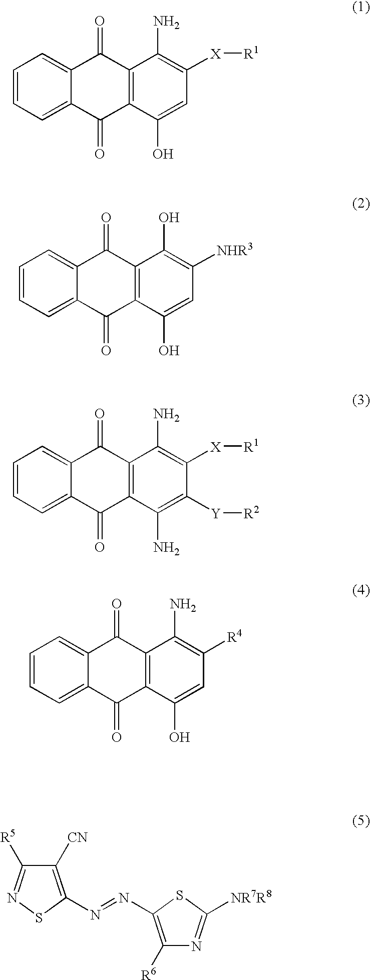

wherein R¹—R³, R⁵, R⁷, R⁸ represents alkyl etc. R⁴ represents cyano etc., R⁶ represents tert-butyl etc., Y is —S— etc.

### BACKGROUND OF THE INVENTION

1. Field of the Invention

The present invention relates to a thermal transfer recording ink sheet, and precisely, the invention is to provide a thermal transfer recording ink sheet capable of forming a record image excellent in the coloring density, the sharpness, the fastness, especially the fastness to light.

2. Background Art

These days, in particular, a color image-forming material is the mainstream of an image-recording material; and concretely, inkjet-type recording materials, thermal transfer-type recording materials, electrophotographic recording materials, transfer-type silver halide photosensitive materials, printing inks and recording pens are much used. Heretofore, various thermal transfer recording systems are known. Thermal transfer recording includes a recording system where a thermal transfer material having a thermofusible ink layer formed on a support (base film) is heated with a thermal head to thereby melt the ink for recording on an image-recording material, and a recording system where a thermal transfer material having a thermal transferable dye-containing dye-donating layer formed on a support is heated with a thermal head to thereby thermally diffuse and transfer the dye onto an image-receiving material. In the latter thermal transfer system, the dye transfer rate may be varied by changing the energy to be applied to the thermal head, therefore facilitating gradation recording, and the system is especially advantageous for high-quality full-color recording. However, the thermal transferable dye for use in this system has various limitations, and only an extremely few dyes are known capable of satisfying all the necessary performance requirements.

However, the full-color image reproduction in the above thermal transfer recording is by subtractive mixture, and in the subtractive mixture, in general, the magenta saturation greatly controls the color reproduction range. A magenta-color azo dye represented by the formula (5) for use in the invention is per-se known, and has excellent spectral characteristics that the molar absorption coefficient is high and the absorption curve is sharp, having little side absorption (see U.S. Pat. No. 5,789,560). The image formed by the use of the magenta dye is extremely sharp and has a high color density with excellent color reproducibility, but is problematic in that its fastness especially to light is low.

### SUMMARY OF THE INVENTION

Accordingly, an object of the invention is to provide a thermal transfer recording ink sheet and a thermal transfer recording method capable of giving, in thermal transfer recording with a sublimable dye, a full-color image that has a high magenta color saturation and is excellent in the coloring density, the sharpness and the fastness, especially the fastness to light.

[1] A thermal transfer recording ink sheet comprising a substrate sheet and a color-carrying layer formed on one surface of the substrate sheet, wherein the dye-carrying layer comprises magenta dyes consisting at least one of anthraquinone dyes of the following formula (1) to (4) and at least one of azo dyes of the following formula (5):

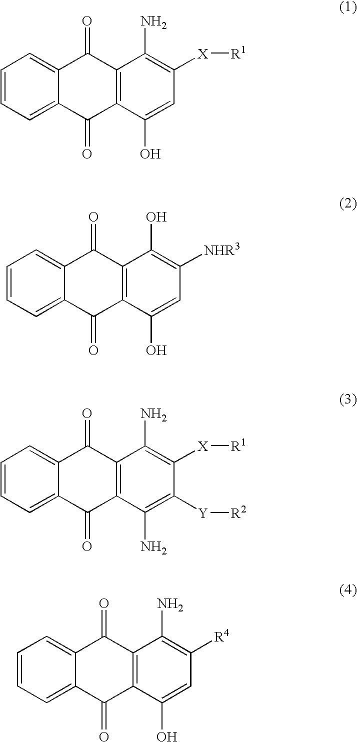

wherein X and Y each independently represent —S—, —O— or —SO₂—; R¹, R² and R³ each independently represent a substituted or unsubstituted alkyl group, a substituted or unsubstituted cycloalkyl group, a substituted or unsubstituted aryl group, or a substituted or unsubstituted allyl group; R⁴ represents a halogen atom or a cyano group;

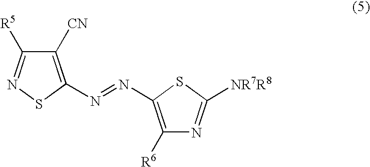

wherein R⁵ represents a substituted or unsubstituted alkyl group having from 1 to 4 carbon atoms, a substituted or unsubstituted phenyl group, a substituted or unsubstituted heterocyclic group; R⁶ represents a tert-butyl group or a tert-pentyl group; R⁷ and R⁸ each independently represent a substituted or unsubstituted alkyl group having from 1 to 10 carbon atoms, a substituted or unsubstituted cycloalkyl group having from 5 to 7 carbon atoms, an alkenyl group having 3 or 4 carbon atoms, or a substituted or unsubstituted phenyl group; and R⁷ and R⁸ may bond to each other to form a 5- or 6-membered ring.

[2] A thermal transfer recording method of forming an image by use of the thermal transfer recording ink sheet of the above [1] on an image-receiving material comprising a polymer-containing ink-receiving layer on a support.

Using specific dyes as mixed according to the invention makes it possible to provide a thermal transfer recording ink sheet and a thermal transfer recording method capable of giving a full-color image that has a high magenta color saturation and is excellent in the coloring density, the sharpness and the fastness, especially the fastness to light.

### BEST MODE FOR CARRYING OUT THE INVENTION

The invention is described in more detail with reference to the preferred embodiments thereof given hereunder.

The anthraquinone dye for use in the invention include those of the above-mentioned formulae (1) to (4), and these dyes may be used either singly or as their mixture. In particular, at least two those anthraquinone dyes may be combined and used to produce a more preferably magenta color.

On the other hand, the azo dye for use in the invention is a dye represented by the above-mentioned formula (5), and this dye may be used either singly or as its mixture.

The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

The anthraquinone dye and the azo dye for use in the invention are described in detail hereinunder.

In formulae (1) to (4), X and Y each represent —S—, —O— or —SO₂—; R¹, R² and R³ each independently represent a substituted or unsubstituted alkyl, cycloalkyl, aryl or allyl group; R⁴ represents a halogen atom or a cyano group.

In formula (5), R⁵ represents a substituted or unsubstituted alkyl group having from 1 to 4 carbon atoms, a substituted or unsubstituted phenyl group, a substituted or unsubstituted heterocyclic group, R⁶ represents a tert-butyl group or a tert-pentyl group; R⁷ and R⁸ each independently represent a substituted or unsubstituted alkyl group having from 1 to 10 carbon atoms, a substituted or unsubstituted cycloalkyl group having from 5 to 7 carbon atoms, an alkenyl group having 3 or 4 carbon atoms, or a substituted or unsubstituted phenyl group. In this, R⁷ and R⁸ may bond to each other to form a 5- or 6-membered ring.

Substituents with which the groups of R¹, R², R³, R⁵, R⁶ and R⁷ may be further substituted are described below in detail.

The halogen atom includes a fluorine atom, a chlorine atom, a bromine atom and an iodine atom. Above all, preferred are a chlorine atom and a bromine atom; and more preferred is a chlorine atom.

The aliphatic group is a linear, branched or cyclic aliphatic group; and as so mentioned in the above, the saturated aliphatic group includes an alkyl group, a cycloalkyl group, a bicycloalkyl group; and these may be further substituted. Preferably, the number of the carbon atoms constituting the group is from 1 to 30. Its examples include a methyl group, an ethyl group, an n-propyl group, an isopropyl group, a tert-butyl group, an n-octyl group, an eicosyl group, a 2-chloroethyl group, a 2-cyanoethyl group, a benzyl group, a 2-ethylhexyl group. The cycloalkyl group includes a substituted or unsubstituted cycloalkyl group. For the substituted or unsubstituted cycloalkyl group, the cycloalkyl group preferably has from 3 to 30 carbon atoms. Its examples include a cyclohexyl group, a cyclopentyl group, a 4-n-dodecylcyclohexyl group. The bicycloalkyl group is a substituted or unsubstituted bicycloalkyl group having from 5 to 30 carbon atoms, or that is, a monovalent group derived from a bicycloalkane having from 5 to 30 carbon atoms by removing one hydrogen atom therefrom. Its examples include a bicyclo[1.2.2]heptan-2-yl group, a bicyclo[2.2.2]octan-3-yl group. It further includes a tricyclo structure and more multi-cyclo structures.

The unsaturated aliphatic group is a linear, branched or cyclic unsaturated aliphatic group, including an alkenyl group, an cycloalkenyl group, a bicycloalkenyl group, an alkynyl group. The alkenyl group is a linear, branched or cyclic, substituted or unsubstituted alkenyl group. Preferably, the alkenyl group is an unsubstituted or substituted alkenyl group having from 2 to 30 carbon atoms. Its examples include a vinyl group, an allyl group, a prenyl group, a geranyl group, an oleyl group. The cycloalkenyl group is preferably a substituted or unsubstituted cycloalkenyl group having from 3 to 30 carbon atoms, or that is, a monovalent group derived from a cycloalkene having from 3 to 30 carbon atoms by removing one hydrogen atom therefrom. Its examples include a 2-cyclopenten-1-yl group, a 2-cyclohexen-1-yl group. The bicycloalkenyl group includes a substituted or unsubstituted bicycloalkenyl group. The bicycloalkenyl group is preferably a substituted or unsubstituted bicycloalkenyl group having from 5 to 30 carbon atoms, or that is, a monovalent group derived from a bicycloalkene having one double bond by removing one hydrogen atom therefrom. Its examples include a bicyclo[2.2.1]hept-2-en-1-yl group a bicyclo[2-2.2.2]oct-2-en-4-yl group. The alkynyl group is preferably a substituted or unsubstituted alkynyl group having from 2 to 30 carbon atoms, including, for example, an ethynyl group, a propargyl group.

The aryl group is preferably a substituted or unsubstituted aryl group having from 6 to 30 carbon atoms, including, for example, a phenyl group, a p-tolyl group, a naphthyl group, a m-chlorophenyl group, an o-hexadecanoylaminophenyl group. Preferred is a phenyl group optionally having a substituent.

The heterocyclic group is a monovalent group derived from a substituted or unsubstituted, aromatic or non-aromatic heterocyclic compound by removing one hydrogen atom therefrom, and it may form a condensed ring. The heterocyclic group is preferably a 5- or 6-membered heterocyclic group, and the ring-constituting hetero atom is preferably an oxygen atom, a sulfur atom, a nitrogen atom. More preferably, it is a 5- or 6-membered aromatic heterocyclic group having from 3 to 30 carbon atoms. The hetero ring of the heterocyclic group includes a pyridine ring, a pyrazine ring, a pyridazine ring, a pyrimidine ring, a triazine ring, a quinoline ring, an isoquinoline ring, a quinazoline ring, a cinnoline ring, a phthalazine ring, a quinoxaline ring, a pyrrole ring, an indole ring, a furan ring, a benzofuran ring, a thiophene ring, a benzothiophene ring, a pyrazole ring, an imidazole ring, a benzimidazole ring, a triazole ring, an oxazole ring, a benzoxazole ring, a thiazole ring, a benzothiazole ring, an isothiazole ring, a benzisothiazole ring, a thiadiazole ring, an isoxazole ring, a benzisoxazole ring, a pyrrolidine ring, a piperidine ring, a piperazine ring, an imidazolidine ring, a thiazoline ring.

The aliphatic oxy group (typically alkoxy group) includes a substituted or unsubstituted aliphatic oxy group (typically alkoxy group), and preferably has from 1 to 30 carbon atoms. For example, it includes a methoxy group, an ethoxy group, an isopropoxy group, an n-octyloxy group, a methoxyethoxy group, a hydroxyethoxy group, a 3-carboxypropoxy group.

The aryloxy group is preferably a substituted or unsubstituted aryloxy group having from 6 to 30 carbon atoms. Examples of the aryloxy group include a phenoxy group, a 2-methylphenoxy group, a 4-tert-butylphenoxy group, a 3-nitrophenoxy group, a 2-tetradecanoylaminophenoxy group. Preferred is a phenyloxy group optionally having a substituent.

The acyloxy group is preferably a formyloxy group, a substituted or unsubstituted alkylcarbonyloxy group having from 2 to 30 carbon atoms, or a substituted or unsubstituted arylcarbonyloxy group having from 6 to 30 carbon atoms. Examples of the acyloxy group include a formyloxy group, an acetyloxy group, a pivaloyloxy group, a stearoyloxy group, a benzoyloxy group, a p-methoxyphenylcarbonyloxy group.

The carbamoyloxy group is preferably a substituted or unsubstituted carbamoyloxy group having from 1 to 30 carbon atoms. Examples of the carbamoyloxy group include an N,N-dimethylcarbamoyloxy group, an N,N-diethylcarbamoyloxy group, a morpholinocarbonyloxy group, an N,N-di-n-octylaminocarbonyloxy group, an N-n-octylcarbamoyloxy group.

The aliphatic oxycarbonyloxy group (typically alkoxycarbonyloxy group) preferably has from 2 to 30 carbon atoms, and it may have a substituent. For example, it includes a methoxycarbonyloxy group, an ethoxycarbonyloxy group, a tert-butoxycarbonyloxy group, an n-octylcarbonyloxy group.

The aryloxycarbonyloxy group is preferably a substituted or unsubstituted aryloxycarbonyloxy group having from 7 to 30 carbon atoms. Examples of the aryloxycarbonyloxy group include a phenoxycarbonyloxy group, a p-methoxyphenoxycarbonyloxy group, a p-n-hexadecyloxyphenoxycarbonyloxy group. Preferred is a phenoxycarbonyloxy group optionally having a substituent.

The amino group includes an amino group, an aliphatic amino group (typically an alkylamino group), an arylamino group and a heterocyclic amino group. The amino group is preferably a substituted or unsubstituted aliphatic amino group (typically an alkylamino group) having from 1 to 30 carbon atoms, or a substituted or unsubstituted arylamino group having from 6 to 30 carbon atoms. Examples of the amino group include an amino group, a methylamino group, a dimethylamino group, an anilino group, an N-methyl-anilino group, a diphenylamino group, a hydroxyethylamino group, a carboxyethylamino group, a sulfoethylamino group, a 3,5-dicarboxyanilino group, a 4-quinolylamino group.

The acylamino group is preferably a formylamino group, a substituted or unsubstituted alkylcarbonylamino group having from 1 to 30 carbon atoms, or a substituted or unsubstituted arylcarbonylamino having from 6 to 30 carbon atoms. Examples of the acylamino group include a formylamino group, an acetylamino group, a pivaloylamino group, a lauroylamino group, a benzoylamino group, a 3,4,5-tri-n-octyloxyphenylcarbonylamino group.

The aminocarbonylamino group is preferably a substitute or unsubstituted aminocarbonylamino group having from 1 to 30 carbon atoms. Examples of the aminocarbonylamino group include a carbamoylamino group, an N,N-dimethylaminocarbonylamino group, an N,N-diethylaminocarbonylamino group, a morpholinocarbonylamino group. The term “amino” in this group has the same meaning as that of the “amino” in the above-mentioned amino group.

The aliphatic oxycarbonylamino group (typically alkoxycarbonylamino group) preferably has from 2 to 30 carbon atoms, and may have a substituent. For example, it includes a methoxycarbonylamino group, an ethoxycarbonylamino group, a tert-butoxycarbonylamino group, an n-octadecyloxycarbonylamino group, an N-methyl-methoxycarbonylamino group.

The aryloxycarbonylamino group is preferably a substituted or unsubstituted aryloxycarbonylamino group having from 7 to 30 carbon atoms. Examples of the aryloxycarbonylamino group include a phenoxycarbonylamino group, a p-chlorophenoxycarbonylamino group, a m-n-octyloxyphenoxycarbonylamino group. Preferred is a phenyloxycarbonylamino group optionally having a substituent.

The sulfamoylamino group is preferably a substituted or unsubstituted sulfamoylamino group having from 0 to 30 carbon atoms. Examples of the sulfamoylamino group include a sulfamoylamino group, an N,N-dimethylaminosulfonylamino group, an N-n-octylaminosulfonylamino group.

The aliphatic (typically alkyl) or arylsulfonylamino group is preferably a substituted or unsubstituted aliphatic sulfonylamino group (typically an alkylsulfonylamino group) having from 1 to 30 carbon atoms, a substituted or unsubstituted arylsulfonylamino group having from 6 to 30 carbon atoms (preferably a phenylsulfonylamino group optionally having a substituent). For example, it includes a methylsulfonylamino group, a butylsulfonylamino group, a phenylsulfonylamino group, a 2,3,5-trichlorophenylsulfonylamino group, a p-methylphenylsulfonylamino group.

The aliphatic thio group (typically alkylthio group) is preferably a substituted or unsubstituted alkylthio group having from 1 to 30 carbon atoms. Examples of the alkylthio group include a methylthio group, an ethylthio group, an n-hexadecylthio group.

The sulfamoyl group is preferably a substituted or unsubstituted sulfamoyl group having from 0 to 30 carbon atoms. Examples of the sulfamoyl group include an N-ethylsulfamoyl group, an N-(3-dodecyloxypropyl)sulfamoyl group, an N,N-dimethylsulfamoyl group, an N-acetylsulfamoyl group, an N-benzoylsulfamoyl group, an N-(N′-phenylcarbamoyl) sulfamoyl group.

The aliphatic (typically alkyl) or arylsulfinyl group is preferably a substituted or unsubstituted aliphatic sulfinyl group (typically an alkylsulfinyl group) having from 1 to 30 carbon atoms, a substituted or unsubstituted arylsulfinyl group having from 6 to 30 carbon atoms (preferably a phenylsulfinyl group optionally having a substituent). For example, it includes a methylsulfinyl group, an ethylsulfinyl group, a phenylsulfinyl group, a p-methylphenylsulfinyl group.

The aliphatic (typically alkyl) or arylsulfonyl group is preferably a substituted or unsubstituted aliphatic sulfonyl group (typically an alkylsulfonyl group) having from 1 to 30 carbon atoms, a substituted or unsubstituted arylsulfonyl group having from 6 to 30 carbon atoms (preferably a phenylsulfonyl group optionally having a substituent). For example, it includes a methylsulfonyl group, an ethylsulfonyl group, a phenylsulfonyl group, a p-toluenesulfonyl group.

The acyl group is preferably a formyl group, a substituted or unsubstituted aliphatic carbonyl group (typically an alkylcarbonyl group) having front 2 to 30 carbon atoms, a substituted or unsubstituted arylcarbonyl group having from 7 to 30 carbon atoms (preferably a phenylcarbonyl group optionally having a substituent), a substituted or unsubstituted heterocyclic carbonyl group having from 4 to 30 carbon atoms in which the ring bonds to the carbonyl group via its carbon atoms. For example, it includes an acetyl group, a pivaloyl group, a 2-chloroacetyl group, a stearoyl group, a benzoyl group, a p-n-octyloxyphenylcarbonyl group, a 2-pyridylcarbonyl group, a 2-furylcarbonyl group.

The aryloxycarbonyl group is preferably a substituted or unsubstituted aryloxycarbonyl group having from 7 to 30 carbon atoms. Examples of the aryloxycarbonyl group include a phenoxycarbonyl group, an o-chlorophenoxycarbonyl group, an m-nitrophenoxycarbonyl group, a p-tert-butylphenoxycarbonyl group. Preferred is a phenyloxycarbonyl group optionally having a substituent.

The aliphatic oxycarbonyl group (typically alkoxycarbonyl group) preferably has from 2 to 30 carbon atoms, and may have a substituent. For example, it includes a methoxycarbonyl group, an ethoxycarbonyl group, a tert-butoxycarbonyl group, an n-octadecyloxycarbonyl group.

The carbamoyl group is preferably a substituted or unsubstituted carbamoyl group having from 1 to 30 carbon atoms. Examples of the carbamoyl group include a carbamoyl group, an N-methylcarbamoyl group, an N,N-dimethylcarbamoyl group, an N,N-di-n-octylcarbamoyl group, an N-(methylsulfonyl)carbamoyl group.

The aryl or heterocyclic azo group includes, for example, a phenylazo group, a 4-methoxyphenylazo groups a 4-pivaloylaminophenylazo group, a 2-hydroxy-4-propanoylphenylazo group.

The imido group includes, for example, an N-succinimide group, an N-phthalimide group.

In addition to these, further mentioned are a hydroxyl group, a cyano group, a nitro group, a sulfo group, a carboxyl group.

These groups may be further substituted, and the substituents for them may be the above-mentioned substituents.

Specific examples of the anthraquinone dyes and the azo dyes of formulae (1) to (5) for use in the invention are shown below; however, the anthraquinone dyes and the azo dyes of formulae (1) to (5) for use in the invention should not be limitatively interpreted by the following examples.

Examples of the substituent groups shown in the following tables are preferred substituent groups for them.

TABLE 1
Dyes of Formula (1)

| No. | X | R¹ |
|---|---|---|
| 1-1 | —O— | phenyl |
| 1-2 | —O— | 3-methylphenyl |
| 1-3 | —S— | 3-propylphenyl |
| 1-4 | —OSO₂— | phenyl |

TABLE 2
Dyes of Formula (2)

| No. | R³ |
|---|---|
| 2-1 | 6-methyloctyl |
| 2-2 | 3-isopropylcyclohexyl |
| 2-3 | 2-cyclohexylethyl |

TABLE 3
Dyes of Formula (3)

| No. | X | Y | R¹ | R² |
|---|---|---|---|---|
| 3-1 | —O— | —O— | phenyl | phenyl |
| 3-2 | —O— | —O— | 3-propylphenyl | 3-propylphenyl |
| 3-3 | —O— | —O— | 3,4-dichlorophenyl | phenyl |

TABLE 4
Dyes of Formula (4)

| No. | R³ |
|---|---|
| 4-1 | cyano |
| 4-2 | chlorine |
| 4-3 | bromine |

TABLE 5
Dyes of Formula (5)

| No. | R⁵ | R⁶ | R⁷ | R⁸ |
|---|---|---|---|---|
| 5-1 | methyl | tert-butyl | ethyl | ethyl |
| 5-2 | phenyl | tert-butyl | ethyl | ethyl |
| 5-3 | tert-butyl | tert-butyl | ethyl | phenyl |
| 5-4 | 2-thienyl | tert-butyl | ethyl | benzyl |
| 5-5 | methyl | tert-butyl | n-propyl | n-propyl |
| 5-6 | methyl | tert-butyl | isopropyl | isopropyl |
| 5-7 | methyl | tert-butyl | n-butyl | n-butyl |
| 5-8 | phenyl | tert-butyl | n-butyl | n-butyl |
| 5-9 | methyl | tert-pentyl | ethyl | ethyl |
| 5-10 | phenyl | tert-pentyl | ethyl | ethyl |

These anthraquinone dyes are known by themselves as disperse dyes, etc.; and their commercial products may be used in the invention. The azo dyes may be produced according to the method described in U.S. Pat. No. 5,789,560.

### [Thermal Transfer Recording Ink Sheet]

The thermal transfer recording ink sheet of the invention is characterized by containing the anthraquinone dye of formulae (1) to (4) and the azo dye of formula (5). The thermal transfer recording ink sheet generally has a structure with a dye-donating layer formed on a support, in which the dye-donating layer contains the dyes. The thermal transfer recording ink sheet of the invention may be produced as follows: A dye is dissolved in a solvent along with a binder therein or dispersed as particles in a solvent, thereby preparing an ink liquid, then the ink liquid is applied onto a support and suitably dried to form a dye-donating layer thereon.

As the support of the thermal transfer recording ink sheet of the invention, any ordinary one heretofore used as a support for ink sheets may be suitably selected and used. For example, the material described in JP-A 7-137466, paragraph [0050] may be favorably used. The thickness of the support is preferably from 2 to 30 μm.

Not specifically defined, the binder resin usable in the dye-donating layer of the thermal transfer recording ink sheet of the invention may be any one having high heat resistance and not interfering with the transference of the dye into an image-receiving material when heated. For example, its preferred examples are described in JP-A 7-137466, paragraph [0049]. The solvent for dye-donating layer formation may also be any conventional known one; and those described in JP-A 7-137466, Examples are favorably used also herein.

Though varying depending on the specific dyes selected for use in the invention, it is desirable that the blend ratio by weight of the anthraquinone dye of formulae (1) to (4) to the azo dye of formula (5) to be in the dye-donating layer is generally from 5/95 to 95/5. In case where the proportion of the anthraquinone dye is too large, then it is unsatisfactory in that the coloring density may lower and the color reproducibility may worsen; but on the other hand, when it is too small, then it is also unsatisfactory in that the light fastness may lower.

The content of the dye mixture in the dye-donating layer is preferably from 0.03 to 1.0 g/m², more preferably from 0.1 to 0.6 g/m². The thickness of the dye-donating layer is preferably from 0.2 to 5 μm, more preferably from 0.4 to 2 μm.

The thermal transfer recording ink sheet of the invention may have any other layer than the dye-donating layer within a range not too much detracting from the effect of the invention. For example, an interlayer may be provided between the support and the dye-donating layer; or a back layer may be provided on the surface of the support opposite to the side of the dye-donating layer (this is hereinafter referred to as “back surface”). The interlayer includes, for example, an undercoating layer, and a diffusion-preventing layer for preventing the dye from diffusing toward the support (hydrophilic barrier layer). The back layer is, for example, a heat-resistant slip layer, which is for preventing a thermal head from sticking to the ink sheet.

In case where the invention is applied to thermal transfer recording material that enables full-color image recording, it is desirable that a cyan ink sheet containing a thermal diffusible cyan dye capable of forming cyan images, a magenta ink sheet containing a thermal diffusible magenta dye capable of forming magenta images, and a yellow ink sheet containing a thermal diffusible yellow dye capable of forming yellow images are formed successively on a support. If desired, an ink sheet containing a black image-forming substance may be further formed.

As the thermal diffusible cyan dye-containing cyan ink sheet for forming cyan images, for example, preferably used are those described in JP-A 3-103477, 3-150194. As the thermal diffusible yellow dye-containing yellow ink sheet for forming yellow images, for example, preferably used are those described in JP-A 1-225592.

### [Thermal Transfer Recording]

In thermal transfer recording by the use of the thermal transfer recording ink sheet of the invention, a heating unit such as a thermal head and an image-receiving material are used as combined. Specifically, heat energy is applied to the ink sheet from a thermal head according to an image recording signal, and the dye in the part having received the heat energy is transferred to and fixed in an image-receiving material to attain image recording. The image-receiving material generally has a constitution with a polymer-containing ink-receiving layer formed on a support. As the constitution and the constitutive components of the image-receiving material, for example, preferably used are those described in JP-A 7-137466, paragraphs [0056] to [0074].

### EXAMPLES

The characteristics of the invention are described more concretely with reference to Production Examples and Examples given below.

In the following Examples, the material used, its amount and the ratio, the details of the treatment and the treatment process may be suitably modified or changed not overstepping the scope of the invention. Accordingly, the invention should not be limitatively interpreted by the Examples mentioned below.

### <Construction of Thermal Transfer Recording Ink Sheet>

A polyester film (Lumirror, trade name by Toray) having a thickness of 6.0 μm and processed for heat-resistant lubrication with a thermosetting acrylic resin (thickness 1 μm) on its back was used as a support. Using a wire bar coater, a dye-donating layer-forming coating composition mentioned below was applied onto the surface of the film to form thereon a layer having a dry thickness of 1 μm, thereby constructing an ink sheet 1.

### (Dye-Donating Layer-Forming Coating Composition)

| | |
|---|---|
| Compound (1-1) | 2.0 mas. pts. |
| Compound (5-1) | 2.0 mas. pts. |
| Polyvinylbutyral resin (Eslec BX-1, trade name by Sekisui | 4.5 mas. pts. |
| Chemical Industry) | |
| Methyl ethyl ketone/toluene (1/1) | 90 mas. pts. |

Next, ink sheets 2 to 36 of the invention and comparative ink sheets 37 to 50 were constructed in the same manner as that for the ink sheet 1, for which, however, the compound (1-1) and the compound (5-1) were changed to the dyes shown in Table 6 below.

### <Construction of Image-Receiving Material>

Synthetic paper (Yupo FFSG200, trade name by Yupo Corporation, thickness: 200 μm) was used as a support. A white interlayer-forming coating composition and a receiving layer-forming coating composition mentioned below were applied in that order onto one surface of the support, using a bar coater. Their amount was so controlled that the white interlayer could have a dry thickness of 1.0 g/m² and the receiving layer could have a dry thickness of 4.0 g/m². The layers were dried at 110° C. for 30 seconds each.

### (White Interlayer-Forming Coating Composition)

| | | |
|---|---|---|
| Polyester resin (Vylon 200, trade name by TOYOBO) | 10 | mas. pts. |
| Fluorescent brightener (Uvitex OB, trade name by | 1 | mas. pt. |
| Ciba-Geigy) | | |
| Titanium oxide | 30 | mas. pts. |
| Methyl ethyl ketone/toluene (1/1) | 90 | mas. pts. |

### (Receiving Layer-Forming Coating Composition)

Vinyl chloride-vinyl acetate resin (Solbine A, trade name by

| | |
|---|---|
| Vinyl chloride-vinyl acetate resin (Solbine A, trade | 100 mas. pts. |
| name by Nisshin Chemical Industry) | |
| Amino-modified silicone (X22-3050C, trade name by | 5 mas. pts. |
| Shin-etsu Chemical Industry) | |
| Epoxy-modified silicone (X22-300E, trade name by | 5 mas. pts. |
| Shin-etsu Chemical Industry) | |
| Methyl ethyl ketone/toluene (=1/1) | 400 mas. pts. |
| Benzotriazole-type UV absorbent (Tinuvin 900, trade | 5 mas. pts. |
| name by Ciba Speciality Chemicals) | |

### <Image Recording and Evaluation>

The ink sheet 1 and the image-receiving material constructed as above were combined in such a manner that the dye-donating layer could face the image-receiving layer, and this was printed using a thermal head applied to the back of the dye-donating material. The output power of the thermal head was 0.25 W/dot, pulse width was from 0.15 to 15 msec, the dot density was 6 dots/mm. In that manner, the magenta dye was imagewise fixed on the image-receiving layer of the image-receiving material, and as a result, a sharp image print with no transfer unevenness was obtained. The ink sheets 2 to 50 were used in place of the ink sheet 1, tested for image recording.

The obtained magenta images were observed by eyes to evaluate in 4 ranks as follows: Very clear A; clear B; slightly unclear C; unclear D. The results are shown in Table 6 below. The solid density (100% dot density) of each image was measured as the status A reflection density thereof, and the samples were evaluated for their transferability in 3 ranks, as follows: Those having a reflection density of at least 1.8 are excellent, A; those having from 1.6 to less than 1.8 are good, B; those having from 1.0 to less than 1.6 are average, C. The results are shown in Table 6 below.

Next, the recorded samples were exposed to an Xe light (17000 lux) for 7 days, and tested for the light stability (light fastness) of the recorded images. After the exposure, the status A reflection density of the part of each sample having an original status A reflection density of 1.0 before the exposure was measured, and the retention (by percentage) to the reflection density of 1.0 after exposure to that before exposure indicates the image stability. With the retention percentage, the samples were ranked in three, A (from 90% to less than 100%), B (from 80% to less than 90%), C (less than 80%). The results are shown in Table 6 below.

TABLE 6

| | Anthraquinone | | | | | | | |
|---|---|---|---|---|---|---|---|---|
| | Dye | | Azo Dye | | | | | |
| | No. in | Amount | No. in | Amount | Color | | Light | |
| No. | Tables | Used | Tables | Used | Reproducibility | Transferability | Fastness | Remarks |
| 1 | 1-1 | 2.0 | 5-1 | 2.0 | A | A | A | the |
| | | | | | | | | Invention |
| 2 | 1-1 | 2.0 | 5-2 | 2.0 | A | A | A | the |
| | | | | | | | | Invention |
| 3 | 1-1 | 2.0 | 5-3 | 2.0 | A | A | A | the |
| | | | | | | | | Invention |
| 4 | 1-1 | 2.0 | 5-4 | 2.0 | A | A | A | the |
| | | | | | | | | Invention |
| 5 | 1-1 | 2.0 | 5-5 | 2.0 | A | A | A | the |
| | | | | | | | | Invention |
| 6 | 1-1 | 2.0 | 5-6 | 2.0 | A | A | A | the |
| | | | | | | | | Invention |
| 7 | 1-1 | 2.0 | 5-7 | 2.0 | A | A | A | the |
| | | | | | | | | Invention |
| 8 | 1-1 | 2.0 | 5-8 | 2.0 | A | A | A | the |
| | | | | | | | | Invention |
| 9 | 1-1 | 2.0 | 5-9 | 2.0 | A | A | A | the |
| | | | | | | | | Invention |
| 10 | 1-1 | 2.0 | 5-10 | 2.0 | A | A | A | the |
| | | | | | | | | Invention |
| 11 | 1-2 | 2.0 | 5-1 | 2.0 | A | A | A | the |
| | | | | | | | | Invention |
| 12 | 1-3 | 2.0 | 5-1 | 2.0 | A | A | A | the |
| | | | | | | | | Invention |
| 13 | 1-4 | 2.0 | 5-1 | 2.0 | A | A | A | the |
| | | | | | | | | Invention |
| 14 | 2-1 | 2.0 | 5-1 | 2.0 | A | A | A | the |
| | | | | | | | | Invention |
| 15 | 2-1 | 2.0 | 5-2 | 2.0 | A | A | A | the |
| | | | | | | | | Invention |
| 16 | 2-2 | 2.0 | 5-1 | 2.0 | A | A | A | the |
| | | | | | | | | Invention |
| 17 | 2-2 | 2.0 | 5-1 | 2.0 | A | A | A | the |
| | | | | | | | | Invention |
| 18 | 3-1 | 2.0 | 5-1 | 2.0 | A | A | A | the |
| | | | | | | | | Invention |
| 19 | 3-1 | 2.0 | 5-2 | 2.0 | A | A | A | the |
| | | | | | | | | Invention |
| 20 | 3-1 | 2.0 | 5-3 | 2.0 | A | A | A | the |
| | | | | | | | | Invention |
| 21 | 3-1 | 2.0 | 5-4 | 2.0 | A | A | A | the |
| | | | | | | | | Invention |
| 22 | 3-1 | 2.0 | 5-5 | 2.0 | A | A | A | the |
| | | | | | | | | Invention |
| 23 | 3-1 | 2.0 | 5-6 | 2.0 | A | A | A | the |
| | | | | | | | | Invention |
| 24 | 3-1 | 2.0 | 5-7 | 2.0 | A | A | A | the |
| | | | | | | | | Invention |
| 25 | 3-1 | 2.0 | 5-8 | 2.0 | A | A | A | the |
| | | | | | | | | Invention |
| 26 | 3-1 | 2.0 | 5-9 | 2.0 | A | A | A | the |
| | | | | | | | | Invention |
| 27 | 3-1 | 2.0 | 5-10 | 2.0 | A | A | A | the |
| | | | | | | | | Invention |
| 28 | 3-2 | 2.0 | 5-1 | 2.0 | A | A | A | the |
| | | | | | | | | Invention |
| 29 | 3-3 | 2.0 | 5-1 | 2.0 | A | A | A | the |
| | | | | | | | | Invention |
| 30 | 4-1 | 2.0 | 5-1 | 2.0 | A | A | A | the |
| | | | | | | | | Invention |
| 31 | 4-1 | 2.0 | 5-2 | 2.0 | A | A | A | the |
| | | | | | | | | Invention |
| 32 | 4-2 | 2.0 | 5-1 | 2.0 | A | A | A | the |
| | | | | | | | | Invention |
| 33 | 4-2 | 2.0 | 5-2 | 2.0 | A | A | A | the |
| | | | | | | | | Invention |
| 34 | 4-3 | 2.0 | 5-1 | 2.0 | A | A | A | the |
| | | | | | | | | Invention |
| 35 | 1-1 | 1.0 | 5-1 | 2.0 | A | A | A | the |
| | 3-1 | 1.0 | | | | | | Invention |
| 36 | 1-1 | 1.0 | 5-2 | 2.0 | A | A | A | the |
| | 3-1 | 1.0 | | | | | | Invention |
| 37 | 1-1 | 4.0 | — | — | C | C | A | Comparative |
| | | | | | | | | Example |
| 38 | 1-2 | 4.0 | — | — | C | C | A | Comparative |
| | | | | | | | | Example |
| 39 | 1-3 | 4.0 | — | — | C | C | A | Comparative |
| | | | | | | | | Example |
| 40 | 1-4 | 4.0 | — | — | C | C | A | Comparative |
| | | | | | | | | Example |
| 41 | 2-1 | 4.0 | — | — | D | C | A | Comparative |
| | | | | | | | | Example |
| 42 | 2-2 | 4.0 | — | — | D | C | A | Comparative |
| | | | | | | | | Example |
| 43 | 2-3 | 4.0 | — | — | D | C | A | Comparative |
| | | | | | | | | Example |
| 44 | 3-1 | 4.0 | — | — | C | C | A | Comparative |
| | | | | | | | | Example |
| 45 | 3-2 | 4.0 | — | — | C | C | A | Comparative |
| | | | | | | | | Example |
| 46 | 3-3 | 4.0 | — | — | C | C | A | Comparative |
| | | | | | | | | Example |
| 47 | — | — | 5-1 | 4.0 | A | A | B | Comparative |
| | | | | | | | | Example |
| 48 | — | — | 5-2 | 4.0 | A | A | B | Comparative |
| | | | | | | | | Example |
| 49 | — | — | 5-3 | 4.0 | A | A | B | Comparative |
| | | | | | | | | Example |
| 50 | — | — | 5-4 | 4.0 | A | A | B | Comparative |
| | | | | | | | | Example |

As a result of the above-mentioned image-recording tests, it is known that mixing specific dyes according to the invention provides a thermal transfer recording ink sheet and a thermal transfer recording method capable of giving an image that has a high magenta color saturation and is excellent in the coloring density, the sharpness and the fastness, especially the fastness to light. Unexpectedly, in addition, it is known that the ink has excellent storage stability and therefore has long-term storability.

The present disclosure relates to the subject matter contained in Japanese Patent Application No. 092236/2007 filed on Mar. 30, 2007, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A thermal transfer recording ink sheet comprising a substrate sheet and a color-carrying layer formed on one surface of the substrate sheet, wherein the dye-carrying layer comprises magenta dyes consisting at least one of anthraquinone dyes of the following formula (1) to (4) and at least one of azo dyes of the following formula (5): 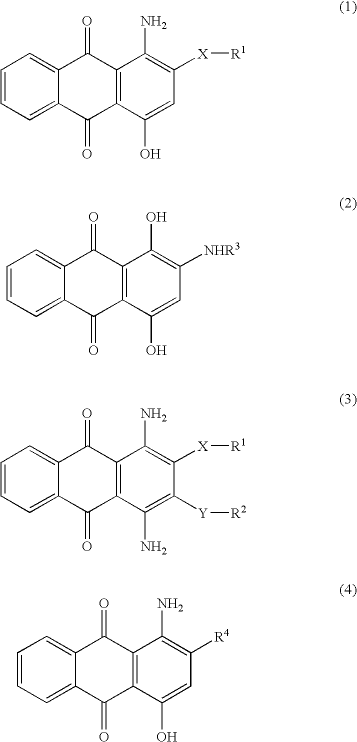
wherein X and Y each independently represent —S—, —O— or —SO₂—; R¹, R² and R³ each independently represent a substituted or unsubstituted alkyl group, a substituted or unsubstituted cycloalkyl group, a substituted or unsubstituted aryl group, or a substituted or unsubstituted allyl group; R⁴ represents a halogen atom or a cyano group; 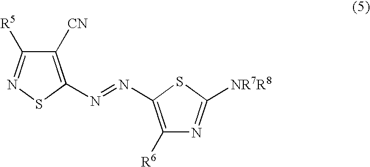
wherein R⁵ represents a substituted or unsubstituted alkyl group having from 1 to 4 carbon atoms, a substituted or unsubstituted phenyl group, a substituted or unsubstituted heterocyclic group; R⁶ represents a tert-butyl group or a tert-pentyl group; R⁷ and R⁸ each independently represent a substituted or unsubstituted alkyl group having from 1 to 10 carbon atoms, a substituted or unsubstituted cycloalkyl group having from 5 to 7 carbon atoms, an alkenyl group having 3 or 4 carbon atoms, or a substituted or unsubstituted phenyl group; and R⁷ and R⁸ may bond to each other to form a 5- or 6-membered ring.

2. A thermal transfer recording method of forming an image by use of the thermal transfer recording ink sheet of claim 1 on an image-receiving material comprising a polymer-containing ink-receiving layer on a support.
